(19) United States
(12) Patent Application Publication
(10) Pub. No.: US 2021/0036320 A1
(43) Pub. Date: Feb. 4, 2021

(54) LITHIUM ANODE SURFACE MODIFICATION METHOD FOR LITHIUM METAL BATTERY AND LITHIUM METAL BATTERY

(71) Applicant: SOUTH CHINA UNIVERSITY OF TECHNOLOGY, Guangdong (CN)

(72) Inventors: Xunhui XIONG, Guangdong (CN); Gang WANG, Guangdong (CN); Chenghao YANG, Guangdong (CN); Zhihua LIN, Guangdong (CN); Zhang LIN, Guangdong (CN); Meilin LIU, Guangdong (CN)

(73) Assignee: SOUTH CHINA UNIVERSITY OF TECHNOLOGY, Guangdong (CN)

(21) Appl. No.: 16/966,460

(22) PCT Filed: Oct. 31, 2018
(86) PCT No.: PCT/CN2018/113217

§ 371 Date: Jul. 30, 2020

(30) Foreign Application Priority Data
Jan. 31, 2018 (CN) 201810104762.4

(51) Int. Cl. H01M 4/525; H01M 4/131; H01M 4/505; H01M 4/134; H01M 4/36; H01M 10/0525

(52) U.S. Cl. CPC H01M 4/525; H01M 4/131; H01M 4/505; H01M 2300/0045; H01M 4/366; H01M 10/0525; H01M 4/134

(57) ABSTRACT

Disclosed are a lithium anode surface modification method for a lithium metal battery and a lithium metal battery. The modification method comprises the following steps: immersing, in a dry protective gas atmosphere, a lithium metal anode in a fluorine ion-containing liquid, or dropping a fluorine ion-containing liquid on a surface of the lithium metal anode; after fluorination and removal, a protective layer rich in lithium fluoride is formed on the surface of the lithium metal anode, and a lithium metal-coated lithium metal anode is obtained.

### TECHNICAL FIELD

The present disclosure relates to the fields of lithium ion battery anode materials and electrochemistry, and more particularly, to a lithium anode surface modification method for lithium metal batteries, and to a lithium metal battery.

### DESCRIPTION OF RELATED ART

With the continuous development of industry, a large amount of harmful gas and soot generated by combustion of traditional fossil fuels not only seriously affect a natural environment and a social environment, but also pose a great threat to a living environment of human beings. Therefore, it is an urgent task to develop renewable clean energies. Lithium ion batteries are widely used in portable electronic products due to a wide operating voltage, a high discharge capacity, stable discharge and environmental friendliness thereof. In recent years, with the rising of electric vehicles and large-scale energy storage, a corresponding electrode material is required to have a higher specific capacity, a higher energy power density and a longer cycle life. However, an existing lithium secondary battery is far from meeting requirements of an advanced energy storage device due to a limited specific capacity thereof. A lithium metal anode is regarded as a “Holy Grail” in an anode material for the lithium secondary battery due to an ultra-high theoretical specific capacity (3860 mAh/g) thereof and a lowest redox potential (−3.04 V). The lithium metal anode not only may be used in a high-energy density battery such as a lithium air battery, a lithium-sulfur battery and the like, but also may be matched with a lithium ion cathode material to meet requirements of an advanced energy storage material.

However, irregular lithium dendrites easily formed during deposition of the lithium metal anode and an irreversible reaction between the lithium anode and an organic electrolyte result in an irreversible capacity loss and rapid deterioration of a cycle performance. On one hand, the generated lithium dendrite is easy to fall off to form “dead lithium”, which not only reduces a Coulombic efficiency of the battery, but also aggravates a side reaction. On the other hand, the formed lithium dendrite is easy to pierce a separator to cause internal short circuit, and even cause a safety accident such as fire or explosion. In order to solve the above problems, researchers have done a lot of modification works. For example, the Yi Cui's group adopted a connected hollow nanosphere with a certain mechanical strength as a solid electrolyte membrane, which effectively prevented contact between the lithium anode and the electrolyte, significantly inhibited growth of the lithium dendrite and improved the Coulombic efficiency of the material (Nature Nanotechnology, 2014, 9, 618-623). Zhang Qiang, et al., found that lithium ions in the electrolyte may be preferentially deposited at a conductive nitrogen-doped site with a lithium affinity at the beginning of charging through a nitrogen-containing functional group (pyridine nitrogen, pyrrole nitrogen, etc.) with the lithium affinity on nitrogen-doped graphene to form uniformly distributed metal lithium nucleation points. The lithium ions would be uniformly deposited based on these uniform nucleation points during continuous charging, thus avoiding a lithium dendrite problem caused by over-dispersed nucleation points. Under a current density of 1 mA/cm² and a deposition capacity of 1 mAh/cm², when the lithium metal with a nitrogen-doped graphene frame is used as the anode, the Coulombic efficiency thereof may still be maintained at about 98% after 200 cycles (Angewandte Chemie International Edition, 2017, 56, 7764-7768). The above research results provide an idea to inhibit the growth of the lithium dendrite, but these preparation methods are difficult, which are hard to realize large-scale production.

Therefore, a simple and easily operational surface processing method for the lithium metal anode is studied, and a LiF-rich solid electrolyte interface layer is formed after fluorination. As a barrier layer between the lithium anode and the organic electrolyte, the protective film is able to effectively inhibit the occurrence of the side reaction, thus inhibiting the growth of the lithium dendrite and prolonging the cycle performance of the lithium anode.

### SUMMARY

An objective of the present disclosure is to provide a lithium anode surface modification method for a lithium metal battery aiming at the defects of low Coulombic efficiency, lithium dendrite growth and safety problems caused by a lithium metal anode in the prior art. According to the method, a protective layer containing lithium fluoride is formed by a fluorine-containing ionic liquid and a metal lithium through in-situ fluorination, and a lithium metal anode can be better applied to a lithium secondary battery after simple modification.

Another objective of the present disclosure is to provide a lithium metal battery obtained by modification based on the above method.

The objectives of the present disclosure are implemented through the following technical solutions.

A lithium anode surface modification method for a lithium metal battery includes the following steps:

immersing, in a dry protective gas atmosphere, a lithium metal anode in a fluorine-containing ionic liquid, or smearing a fluorine-containing ionic liquid on a surface of the lithium metal anode; after fluorination, taking out the lithium metal anode, and forming a protective layer rich in lithium fluoride on the surface of the lithium metal anode, so as to obtain a lithium fluoride-coated lithium metal anode.

Further, the protective gas is one or more than one of helium, neon and argon.

Further, the fluorine-containing ionic liquid is one or more than one of alkylimidazolium tetrafluoroborate, N-alkylpyridinium tetrafluoroborate, tetraalkyl ammonium fluoroborate, N-alkyl-N-methylpiperidinium tetrafluoroborate, N-alkyl-N-methylpyrrolidinium tetrafluoroborate, tributylalkyl phosphonium tetrafluoroborate, 1-aminopropyl-4-methylimidazolium tetrafluoroborate, 1-ethyl ether-3-alkylimidazolium tetrafluoroborate, 1-propyl sulfonic acid-3 -methylimidazolium tetrafluoroborate, 1-benzyl-3-methylimidazolium tetrafluoroborate and 1-ethyl acetate-3-methylimidazolium tetrafluoroborate.

Further, the fluorination is performed at 10° C. to 60° C. for 30 seconds to 24 hours.

Further, a thickness of the lithium fluoride protective layer is 1 nm to 5 μm.

A lithium metal battery based on the lithium fluoride-coated lithium metal anode obtained by any one of the methods above mainly consists of a cathode, the lithium fluoride-coated lithium metal anode, a separator and an electrolyte.

Further, a material of the cathode is selected from lithium iron phosphate (LiFePO₄), lithium cobalt oxide (LiCO₂), a ternary material (LiNiₓCo_{y}Mn_{1-y}O₂, 0≤x≤1, 0≤y≤1), lithium nickel manganese oxide (LiNi_{0.5}Mn_{1.5}O₄), a lithium-rich material (zLiMnO₂·(1-z)LiMO₂, 0<z<1), ferric fluoride (FeF₃·nH₂O) or sulfur (S).

Further, the separator is selected from a glass fiber film (GF film), a polyethylene film (PE film), a polypropylene film (PP film), a polypropylene/polyethylene double-layer co-extruded film (PP/PE film) or a polypropylene/polyethylene/polypropylene three-layer co-extruded film (PP/PE/PP film).

Further, the electrolyte is selected from an ester electrolyte or an ether electrolyte.

Compared with the prior art, the present disclosure has the following advantages and technical effects:

(1) the method for modifying the lithium metal anode according to the present disclosure has the advantages of simple process, easy operation and good repeatability, which is easy to realize large-scale industrial production;

(2) the lithium fluoride protective layer obtained by surface fluorination according to the present disclosure is very uniform and dense, which can reduce a contact area between the lithium metal anode and the electrolyte, reduce an occurrence of side reactions, reduce a consumption of the lithium metal and the electrolyte, and inhibit repeated formation and rupture of a solid electrolyte interface film (SEI film) during lithium deposition/stripping; meanwhile, the lithium fluoride protective layer can inhibit formation of the lithium dendrite, which significantly improves a safety of a battery system, and, when applied to the metal lithium secondary battery, can effectively improve a discharge specific capacity and a cycle performance of a matched anode material;

(3) the lithium fluoride-coated lithium metal anode obtained by surface fluorination according to the present disclosure has the advantages of higher discharge specific capacity, longer cycle life, better safety performance and the like, which implements the stability and high efficiency of the lithium metal battery in a long cycle process, can meet use requirements of a power battery with high-energy and high-power, is beneficial for promoting an industrialization process of the lithium metal battery, and has a broad application prospect.

### BRIEF DESCRIPTION OF THE DRAWINGS

FIG. 1a is an SEM diagram of a lithium metal anode before fluorination in Embodiment 1.

FIG. 1b is an SEM diagram of the lithium metal anode after fluorination in Embodiment 1.

FIG. 2 is a Coulombic efficiency diagram of a Li|Cu cell assembled by a lithium fluoride-coated lithium metal anode prepared in Embodiment 1 and a copper foil.

FIG. 3 is a charge-discharge graph of a symmetrical cell assembled by a lithium fluoride-coated lithium metal anode prepared in Embodiment 2.

FIG. 4 is a cycle performance diagram of a full cell assembled respectively by a lithium fluoride-coated lithium metal anode prepared in Embodiment 5 and an untreated lithium metal anode with LiNi_{0.6}Co_{0.2}Mn_{0.2}O₂.

FIG. 5 is a charge-discharge graph of the full cell in the condition of the specific cycles assembled respectively by the lithium fluoride-coated lithium metal anode prepared in Embodiment 5 and the untreated lithium metal anode with LiNi_{0.6}Co_{0.2}Mn_{0.2}O₂.

### DESCRIPTION OF THE EMBODIMENTS

The following describes the technical solutions of the present disclosure in further detail with reference to the specific embodiments and accompanying drawings, but the scope of protection and implementation of the present disclosure are not limited thereto.

The experimental methods in the following embodiments are all conventional methods unless otherwise specified.

### Embodiment 1

A lithium metal anode surface modification method included the following steps.

Under the protection of dry argon, a polished lithium metal sheet was immersed in a 25° C. ionic liquid of 1-butyl-2,3-dimethylimidazolium tetrafluoroborate ([BMIm]BF₄), and then taken out after fluorination for 60 minutes. The residual liquid was wiped off with non-sticky wiping paper, and a protective layer rich in lithium fluoride was formed on a surface of the lithium metal sheet, wherein a thickness of the protective layer was 200 nm, thus obtaining a lithium fluoride-coated lithium metal anode.

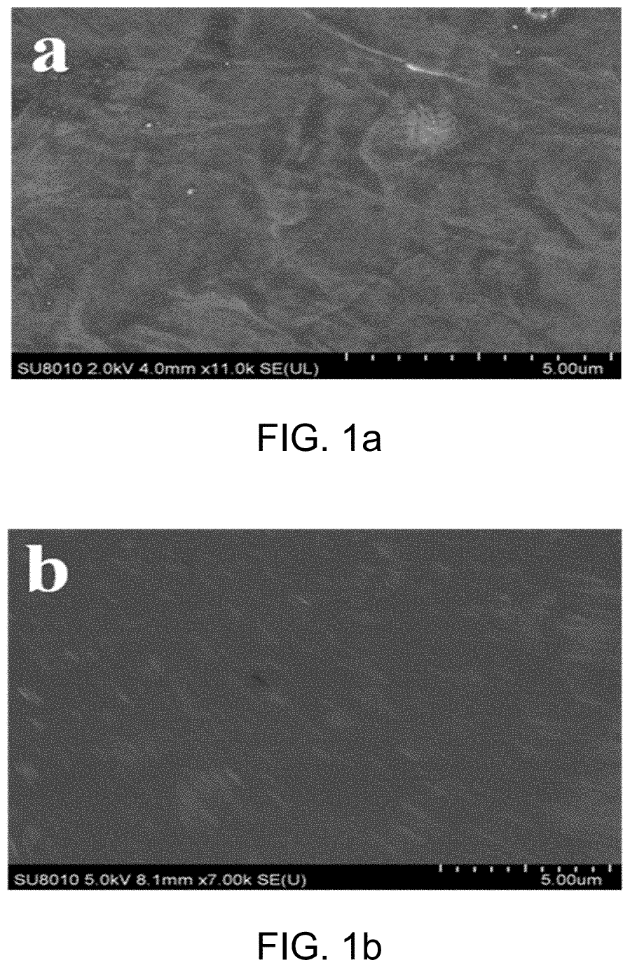

An SEM diagram of the surface of the lithium metal sheet before fluorination was shown in FIG. 1a. It can be seen from FIG. 1a that the surface of the lithium metal sheet before fluorination has an obvious crack and is uneven, while the surface of the lithium metal sheet after fluorination (as shown in FIG. 1b) has no crack and is smooth.

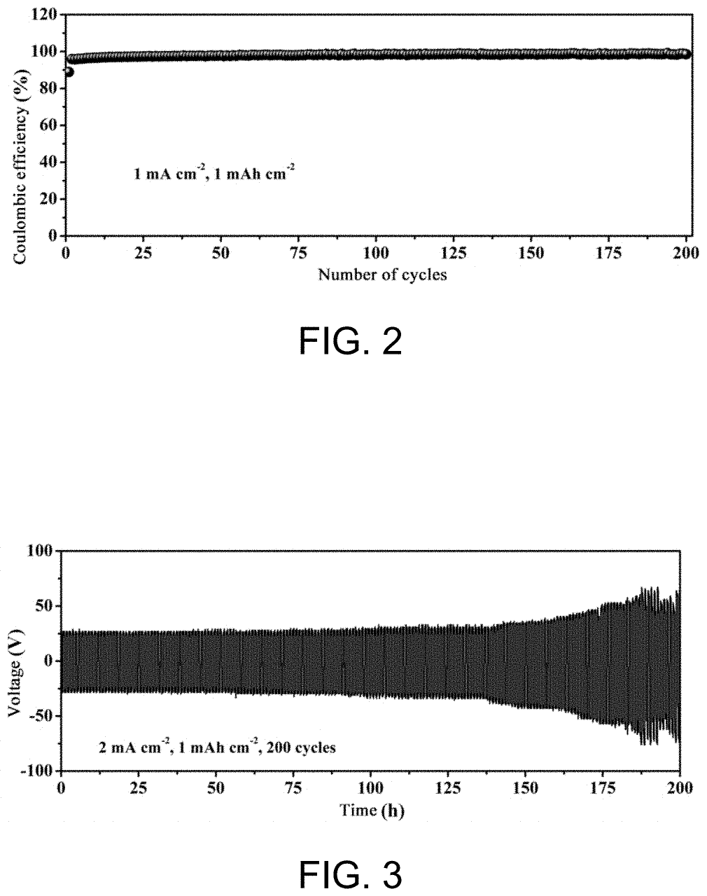

The prepared lithium fluoride-coated lithium metal anode and a copper foil were assembled into a Li|Cu cell. A PE film was used as a separator of the Li|Cu cell, and a mixed solution of lithium bis(trifluoromethanesulphonyl)imide (with a concentration of 1 M in the electrolyte) dissolved in 1,3-dioxolane (DOL)/dimethoxyethane (DME) with a volume ratio of 1:1 and added with 2 wt % LiNO₃ was used as an electrolyte. A discharge performance of the Li|Cu cell was tested, and a Coulombic efficiency diagram of the Li|Cu cell was shown in FIG. 2. It can be seen from FIG. 2 that a current density of the Li|Cu cell is 1 mA/cm², and a Coulombic efficiency thereof is still as high as 98% under a deposition capacity of 1 mAh/cm².

### Embodiment 2

Under the protection of high-pure dry argon, a polished lithium metal sheet was immersed in a 25° C. ionic liquid of 1-ethyl-3-methylimidazolium tetrafluoroborate ([EMIm]BF₄), and then taken out after fluorination for 10 minutes. The residual liquid was wiped off with non-sticky wiping paper, and a protective layer rich in lithium fluoride was formed on a surface of the lithium metal sheet, wherein a thickness of the protective layer was 30 nm, thus obtaining a lithium fluoride-coated lithium metal anode.

The prepared lithium fluoride-coated lithium metal anode was assembled into a symmetrical cell. A PP film was used as a separator, and a mixed solution of lithium bis(trifluoromethanesulphonyl)imide (with a concentration of 1 M in the electrolyte) dissolved in 1,3-dioxolane (DOL)/dimethoxyethane (DME) with a volume ratio of 1:1 and added with 2 wt % LiNO₃ was used as an electrolyte. Under conditions of a current density of 2 mA/cm² and a deposition capacity of 1 mAh/cm², a charge-discharge curve of the symmetrical cell with 200 cycles is shown in FIG. 3. It can be seen from FIG. 3 that the charge-discharge curve of the symmetrical cell is stable, a polarization voltage thereof is lower than 50 mA, and a voltage platform is symmetrical. The results show that the lithium metal anode after fluorination can effectively inhibit growth of a lithium dendrite and show an excellent electrochemical stability.

### Embodiment 3

Under the protection of dry argon, a polished lithium metal sheet was immersed in a 30° C. ionic liquid of 1-hexyl-3-methylimidazolium tetrafluoroborate ([HMIm]BF₄), and then taken out after fluorination for 2 minutes. The residual liquid was wiped off with non-sticky wiping paper, and a protective layer rich in lithium fluoride was formed on a surface of the lithium metal sheet, wherein a thickness of the protective layer was 5 nm, thus obtaining a lithium fluoride-coated lithium metal anode.

The prepared lithium fluoride-coated lithium metal anode was used as an anode and assembled into a full cell with a lithium cobalt oxide cathode material. A PP/PE film was used as a separator of the full cell, and a mixed solution of lithium bis(trifluoromethanesulphonyl)imide (with a concentration of 1 M in the electrolyte) dissolved in 1,3-dioxolane (DOL)/dimethoxyethane (DME) with a volume ratio of 1:1 and added with 8 wt % LiNO₃ was used as an electrolyte. It is found through testing that a discharge specific capacity and a capacity retention rate of the full cell are higher than those of an untreated lithium metal sheet after 200 cycles at a high current density of 0.5 C.

### Embodiment 4

Under the protection of dry neon, a polished lithium metal sheet was immersed in a 15° C. ionic liquid of 1-octyl-3-methylimidazolium tetrafluoroborate ([OMIm]BF₄), and then taken out after fluorination for 20 minutes. The residual liquid was wiped off with non-sticky wiping paper, and a protective layer rich in lithium fluoride was formed on a surface of the lithium metal sheet, wherein a thickness of the protective layer was 45 nm, thus obtaining a lithium fluoride-coated lithium metal anode.

The prepared lithium fluoride-coated lithium metal anode was assembled into a symmetrical cell. A GF film was used as a separator, and a mixed solution of LiPF₆ (with a concentration of 1 M in the electrolyte) dissolved in ethylene carbonate (EC)/dimethyl carbonate (DMC)/ethyl methyl carbonate (EMC) with a volume ratio of 1:1:1 was used as an electrolyte. It is found through testing that under conditions of a current density of 1 mA/cm² and a deposition capacity of 1 mAh/cm², a polarization voltage of the symmetrical cell with 50 cycles is lower than 40 mA, a voltage platform is symmetrical, and a charge-discharge curve was stable. The results show that the lithium metal anode after fluorination can effectively inhibit growth of a lithium dendrite and show an excellent electrochemical stability.

### Embodiment 5

In a glove box filled with dry argon, a polished lithium metal sheet was immersed in a 25° C. ionic liquid of 1-butyl-2,3-dimethylimidazolium tetrafluoroborate ([BMIm]BF₄), and then taken out after fluorination for 60 minutes. The residual liquid was wiped off with non-sticky wiping paper, and a protective layer rich in lithium fluoride was formed on a surface of the lithium metal sheet, wherein a thickness of the protective layer was 200 nm, thus obtaining a lithium fluoride-coated lithium metal anode.

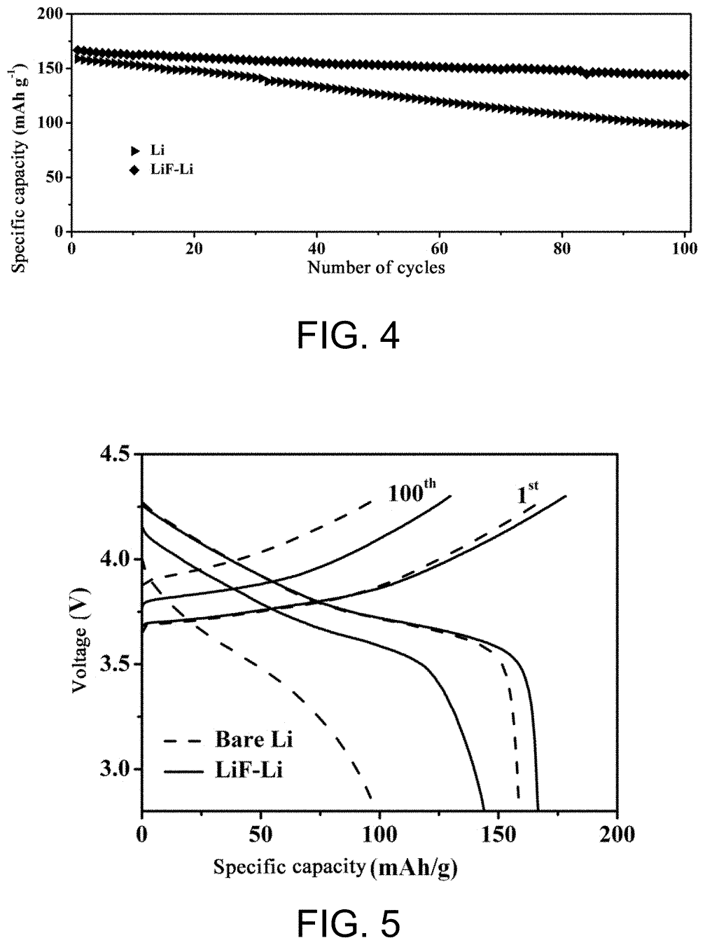

The prepared lithium fluoride-coated lithium metal anode and an untreated lithium metal anode were respectively assembled with a ternary material LiNi_{0.6}Co_{0.2}Mn_{0.2}O₂ respectively into full cells. A PP/PE/PP film was used as a separator of the full cells, and a mixed solution of LiPF₆ (with a concentration of 1 M in the electrolyte) dissolved in ethylene carbonate (EC)/dimethyl carbonate (DMC) with a volume ratio of 1:1 was used as an electrolyte. A cycle performance diagram of the assembled full cells (100 cycles at a high current density of 1 C) and charge-discharge curves under a specific number of cycles are shown in FIG. 4 and FIG. 5 respectively. It can be seen from FIG. 4 and FIG. 5 that a discharge specific capacity and a capacity retention rate are much higher than those of the untreated lithium metal anode.

### Embodiment 6

Under the protection of dry helium, a polished lithium metal sheet was immersed in a 60° C. ionic liquid of 1-dodecyl-3-methylimidazolium tetrafluoroborate ([C₁₂MIm]BF₄), and then taken out after fluorination for 24 hours. The residual liquid was wiped off with non-sticky wiping paper, and a protective layer rich in lithium fluoride was formed on a surface of the lithium metal sheet, wherein a thickness of the protective layer was 3 μm, thus obtaining a lithium fluoride-coated lithium metal anode.

The prepared lithium fluoride-coated lithium metal anode and a copper foil were assembled into a Li|Cu cell. A PE/PP film was used as a separator of the Li|Cu cell, and a mixed solution of lithium bis(trifluoromethanesulphonyl)imide (with a concentration of 1 M in the electrolyte) dissolved in 1,3-dioxolane (DOL)/dimethoxyethane (DME) with a volume ratio of 1:1 and added with 5 wt % LiNO₃ was used as an electrolyte. It is found through testing that a current density of the Li|Cu cell is 5 mA/cm², and a Coulombic efficiency thereof is still as high as 90% under a deposition capacity of 1 mAh/cm².

### Embodiment 7

Under the protection of dry neon, a polished lithium metal sheet was immersed in a 10° C. ionic liquid of 1-hexadecyl-3-methylimidazolium tetrafluoroborate ([C₁₆MIm]BF₄), and then taken out after fluorination for 20 minutes. The residual liquid was wiped off with non-sticky wiping paper, and a protective layer rich in lithium fluoride was formed on a surface of the lithium metal sheet, wherein a thickness of the protective layer was 45 nm, thus obtaining a lithium fluoride-coated lithium metal anode.

The prepared lithium fluoride-coated lithium metal anode was assembled into a symmetrical cell. A GF film was used as a separator, and a mixed solution of lithium bis(trifluoromethanesulphonyl)imide (with a concentration of 1 M in the electrolyte) dissolved in 1,3-dioxolane (DOL)/dimethoxyethane (DME) with a volume ratio of 1:1 and added with 8 wt % LiNO₃ was used as an electrolyte. It is found through testing that under conditions of a current density of 5 mA/cm² and a deposition capacity of 1 mAh/cm², a polarization voltage of the symmetrical cell with 100 cycles is lower than 120 mA, a voltage platform is symmetrical, and a charge-discharge curve was stable. The results show that the lithium metal anode after fluorination can effectively inhibit growth of a lithium dendrite and show an excellent electrochemical stability.

### Embodiment 8

In a glove box filled with high-pure dry argon, a polished lithium metal sheet was immersed in a 40° C. ionic liquid of 1-ethyl-2,3-dimethylimidazolium tetrafluoroborate ([EMMIm]BF₄), and then taken out after fluorination for 5 minutes. The residual liquid was wiped off with non-sticky wiping paper, and a protective layer rich in lithium fluoride was formed on a surface of the lithium metal sheet, wherein a thickness of the protective layer was 90 nm, thus obtaining a lithium fluoride-coated lithium metal anode.

The prepared lithium fluoride-coated lithium metal anode was used as an anode and matched with a LiFePO₄ cathode material to assemble a full cell. A PP film was used as a separator of the full cell, and a mixed solution of LiPF₆ (with a concentration of 1 M in the electrolyte) dissolved in ethylene carbonate (EC)/dimethyl carbonate (DMC)/ethyl methyl carbonate (EMC) with a volume ratio of 1:1:1 was used as an electrolyte. It is found through testing that under conditions of a current density of 0.1 C, a first discharge specific capacity of the full cell is as high as 158.3 mAh/g, and a cycle performance of the full cell is stable. After charge-discharge for 200 cycles, the specific capacity of the full cell still remains at 146.3 mAh/g.

### Embodiment 9

Under the protection of dry helium, a polished lithium metal sheet was immersed in a 30° C. ionic liquid of N-ethylpyridinium tetrafluoroborate ([Epy]BF₄), and then taken out after fluorination for 4 hours. The residual liquid was wiped off with non-sticky wiping paper, and a protective layer rich in lithium fluoride was formed on a surface of the lithium metal sheet, wherein a thickness of the protective layer was 1 μm, thus obtaining a lithium fluoride-coated lithium metal anode.

The prepared lithium fluoride-coated lithium metal anode and a copper foil were assembled into a Li|Cu cell. A GF film was used as a separator of the Li|Cu cell, and a mixed solution of LiPF₆ (with a concentration of 1 M in the electrolyte) dissolved in ethylene carbonate (EC)/ethyl methyl carbonate (EMC) with a volume ratio of 1:1 was used as an electrolyte. It is found through testing that a current density of the Li|Cu cell is 2 mA/cm², and a Coulombic efficiency thereof is still as high as 86% under a deposition capacity of 2 mAh/cm².

### Embodiment 10

Under the protection of dry neon, a polished lithium metal sheet was immersed in a 20° C. ionic liquid of tetramethylammonium tetrafluoroborate ([N1,1,1,1]BF₄), and then taken out after fluorination for 80 minutes. The residual liquid was wiped off with non-sticky wiping paper, and a protective layer rich in lithium fluoride was formed on a surface of the lithium metal sheet, wherein a thickness of the protective layer was 90 nm, thus obtaining a lithium fluoride-coated lithium metal anode.

The prepared lithium fluoride-coated lithium metal anode was assembled into a symmetrical cell. A PE film was used as a separator, and a mixed solution of LiPF₆ (with a concentration of 1 M in the electrolyte) dissolved in ethylene carbonate (EC)/dimethyl carbonate (DMC)/ethyl methyl carbonate (EMC) with a volume ratio of 1:1:1 was used as an electrolyte. It is found through testing that under conditions of a current density of 3 mA/cm² and a deposition capacity of 2 mAh/cm², a polarization voltage of the symmetrical cell with 100 cycles is lower than 80 mA, a voltage platform is symmetrical, and a charge-discharge curve was stable. The results show that the lithium metal anode after fluorination can effectively inhibit growth of a lithium dendrite and show an excellent electrochemical stability.

### Embodiment 11

Under the protection of high-pure dry argon, a polished lithium metal sheet was immersed in a 25° C. ionic liquid of N-butyl-N-methylpyrrolidinium tetrafluoroborate (PP1,4BF₄), and then taken out after fluorination for 15 minutes. The residual liquid was wiped off with non-sticky wiping paper, and a protective layer rich in lithium fluoride was formed on a surface of the lithium metal sheet, wherein a thickness of the protective layer was 30 nm, thus obtaining a lithium fluoride-coated lithium metal anode.

The prepared lithium fluoride-coated lithium metal anode was used as an anode and matched with a Li_{1.5}Mn_{0.54}Co_{0.13}Ni_{0.13}O₂ cathode material to assemble a full cell. A PP/PE/PP film was used as a separator of the full cell, and a mixed solution of LiPF₆ (with a concentration of 1 M in the electrolyte) dissolved in ethylene carbonate (EC)/dimethyl carbonate (DMC) with a volume ratio of 1:1 was used as an electrolyte. It is found through testing that under conditions of a current density of 0.5 C, a first discharge specific capacity of the full cell is as high as 258.7 mAh/g. After charge-discharge for 200 cycles, the specific capacity of the full cell still remains at 236.3 mAh/g, showing an excellent cycle performance.

### Embodiment 12

Under the protection of dry helium, a polished lithium metal sheet was immersed in a 15° C. ionic liquid of 1-aminopropyl-4-methylimidazolium tetrafluoroborate ([APMIm]BF₄), and then taken out after fluorination for 1.5 hours. The residual liquid was wiped off with non-sticky wiping paper, and a protective layer rich in lithium fluoride was formed on a surface of the lithium metal sheet, wherein a thickness of the protective layer was 0.4 μm, thus obtaining a lithium fluoride-coated lithium metal anode.

The prepared lithium fluoride-coated lithium metal anode and a copper foil were assembled into a Li|Cu cell. A PP film was used as a separator of the Li|Cu cell, and a mixed solution of lithium bis(trifluoromethanesulphonyl)imide (with a concentration of 1 M in the electrolyte) dissolved in 1,3-dioxolane (DOL)/dimethoxyethane (DME) with a volume ratio of 1:1 and added with 3 wt % LiNO₃ was used as an electrolyte. It is found through testing that a current density of the Li|Cu cell is 0.5 mA/cm², and a Coulombic efficiency thereof is still as high as 93% under a deposition capacity of 1 mAh/cm².

### Embodiment 13

Under the protection of dry argon, a polished lithium metal sheet was immersed in a 50° C. ionic liquid of 1-propylsulfonic acid-3-methylimidazolium tetrafluoroborate ([PrSO₃HMIm]BF₄), and then taken out after fluorination for 30 minutes. The residual liquid was wiped off with non-sticky wiping paper, and a protective layer rich in lithium fluoride was formed on a surface of the lithium metal sheet, wherein a thickness of the protective layer was 90 nm, thus obtaining a lithium fluoride-coated lithium metal anode.

The prepared lithium fluoride-coated lithium metal anode was assembled into a symmetrical cell. A GF film was used as a separator, and a mixed solution of lithium bis(trifluoromethanesulphonyl)imide (with a concentration of 1 M in the electrolyte) dissolved in 1,3-dioxolane (DOL)/dimethoxyethane (DME) with a volume ratio of 1:1 and added with 2 wt % LiNO₃ was used as an electrolyte. It is found through testing that under conditions of a current density of 0.5 mA/cm² and a deposition capacity of 1 mAh/cm², a polarization voltage of the symmetrical cell with 500 cycles is lower than 50 mA, a voltage platform is symmetrical, and a charge-discharge curve was stable. The results show that the lithium metal anode after fluorination can effectively inhibit growth of a lithium dendrite and show an excellent electrochemical stability.

The above embodiments are only preferred embodiments of the present disclosure, which are only used to explain the present disclosure, not to limit the present disclosure. Any changes, replacements, combinations, simplifications and modifications made by those skilled in the art without departing from the spirit and principle of the present disclosure shall be equivalent substitutions, and shall be included in the scope of protection scope of the present disclosure.

1. A lithium anode surface modification method for a lithium metal battery, wherein the method comprises the following steps:
immersing, in a dry protective gas atmosphere, a lithium metal anode in a fluorine-containing ionic liquid, or dropping the fluorine-containing ionic liquid on a surface of the lithium metal anode, after fluorination, taking out the lithium metal anode, and forming a protective layer rich in lithium fluoride on the surface of the lithium metal anode, so as to obtain a lithium fluoride-coated lithium metal anode.

2. The lithium anode surface modification method for the lithium metal battery according to claim 1, wherein the protective gas is one or more than one of helium, neon and argon.

3. The lithium anode surface modification method for the lithium metal battery according to claim 1, wherein the fluorine-containing ionic liquid is one or more than one of alkylimidazolium tetrafluoroborate, N-alkylpyridinium tetrafluoroborate, tetraalkyl ammonium fluoroborate, N-alkyl-N-methylpiperidinium tetrafluoroborate, N-alkyl-N-methylpyrrolidinium tetrafluoroborate, tributylalkyl phosphonium tetrafluoroborate, 1-aminopropyl-4-methylimidazolium tetrafluoroborate, 1-ethyl ether-3-alkylimidazolium tetrafluoroborate, 1-propyl sulfonic acid-3-methylimidazolium tetrafluoroborate, 1-benzyl-3-methylimidazolium tetrafluoroborate and 1-ethyl acetate-3-methylimidazolium tetrafluoroborate.

4. The lithium anode surface modification method for the lithium metal battery according to claim 1, wherein the fluorination is performed at 10° C. to 60° C. for 30 seconds to 24 hours.

5. The lithium anode surface modification method for the lithium metal battery according to claim 1, wherein a thickness of the lithium fluoride protective layer is 1 nm to 5 μm.

6. A lithium metal battery based on the lithium fluoride-coated lithium metal anode obtained by the method according to claim 1, wherein the lithium metal battery mainly consists of a cathode, the lithium fluoride-coated lithium metal anode, a separator and an electrolyte.

7. The lithium metal battery according to claim 6, wherein a material of the cathode is selected from a group consisting of lithium iron phosphate, lithium cobalt oxide, a ternary material, lithium nickel manganese oxide, a lithium-rich layered oxide, ferric fluoride and sulfur.

8. The lithium metal battery according to claim 6, wherein the separator is selected from a group consisting of a glass fiber film, a polyethylene film, a polypropylene film, a polypropylene/polyethylene film and a polypropylene/polyethylene/polypropylene film.

9. The lithium metal battery according to claim 6, wherein the electrolyte is selected from a group consisting of an ester electrolyte and an ether electrolyte.
